(19) United States
(12) Patent Application Publication
(10) Pub. No.: US 2009/0086259 A1
(43) Pub. Date: Apr. 2, 2009

(54) METHOD AND SYSTEM FOR PROVIDING BACKWARD COMPATIBILITY FOR A NEW VERSION OF A PAGE DESCRIPTION LANGUAGE

(75) Inventors: Martin Bailey, Cambridge (GB); Adrian Ford, Woodinville, WA (US)

Correspondence Address: DARBY & DARBY P.C., P.O. BOX 770, Church Street Station, New York, NY, 10008-0770, US

(73) Assignee: Global Graphics Software Limited

(21) Appl. No.: 12/140,783

(22) Filed: Jun. 17, 2008

Related U.S. Application Data
(60) Provisional application No. 60/945,547, filed on Jun. 21, 2007.

(51) Int. Cl. G06F 3/12

(52) U.S. Cl. 358/1.15

(57) ABSTRACT

A method of providing backward compatibility for a newer version of a page description language to a system comprising a computer and a printer coupled to the computer, where the printer is configured and arranged for operation with an earlier version of the page description language and has not been updated for the newer version of the page description language, includes providing an updated printer driver with a component that incorporates information about the printer to convert a file in the newer version of the page description language into a file in the earlier version of the page description language while substantially retaining a same visual appearance of the file when printed and compared to the file printed by a printer configured and arranged to print the file using the newer version of the page description language. The updated printer driver is stored on the computer.

### CROSS-REFERENCE TO RELATED APPLICATIONS

This application claims the benefit under 35 U.S.C. 119(e) of U.S. Provisional Patent Application Ser. No. 60/945,547 filed on Jun. 21, 2007, which is herein incorporated by reference.

### FIELD

The present invention is directed to methods, systems, and devices that can be used for providing backward compatibility to a printer or printer system for a new version of a page description language. The present invention is also directed to methods, systems, and devices that include an updated printer driver to provide the backward compatibility.

### BACKGROUND

When a document or other graphical construct is printed, whether on a desktop printer or in the prepress department of a commercial printer, the application from which it is printed converts the data into what is called a spool file format. This is usually done in cooperation with the printer subsystem within the operating system of the computer.

When printing to the least sophisticated devices, the spool file format is then usually interpreted within the print subsystem, and converted into some form of raster, or simple page description language (PDL) before being passed on to the printer. For more sophisticated devices, the spool file format may be converted to a more complex PDL, or, in some cases, may be passed through in the original format to the printing device.

The communication between the print subsystem and the printing device may be via a number of methods, including over a network, a USB, firewire or parallel cable, or by writing to file and then onward transmission on floppy disk, CD, DVD, flash memory or by some other media, or by transmission using email, FTP, etc.

One part of these more sophisticated devices is a Raster Image Processor (RIP), which can interpret the PDL and can convert that into a form that other parts of the printing device can understand, and can actually mark onto the print medium.

There are a variety of commonly used page description languages, including Printer Control Language (PCL) defined by Hewlett-Packard, PostScript and the Portable Document Format (PDF) both defined by Adobe Systems, and the XML Paper Specification (XPS) defined by Microsoft. Of these, PostScript and PCL are older formats, while PDF and XPS are more recent. Note that these four specific PDLs are referred to throughout this document only as illustrations; there are many more PDLs in use.

The spool file format in use depends on the operating system and print subsystem from which a document is printed. When printing on an Apple Macintosh under Mac OS X, the spool file format is PDF. When printing from Microsoft Windows versions earlier than Windows Vista (with some minor exceptions), the spool file format will be the Graphics Device Interface (GDI). Microsoft Windows Vista continues to support a GDI-based print subsystem, but also includes a new print subsystem where the spool file format is XPS. Other operating systems are available with a variety of print subsystems and using a variety of spool file formats.

The examples above include two situations where the spool file format is a PDL that can be passed directly to a print device without the data being touched in any way: printing from Mac OS X to a device that includes a PDF RIP, and printing from Windows Vista through the XPS print subsystem to a device that includes an XPS RIP. In these, and similar cases under other operating systems, a very simple printer driver is used. Such drivers usually do nothing but pass the spool file format directly on to the component of the print subsystem that communicates with the printer over the network, USB cable etc (in Windows terminology this is known as the “port monitor”).

New versions of spool file formats are released from time to time, and the manufacturers of printing devices often need to be able to respond to such changes. For instance, the current version of PDF is 1.7, which is the 8th version released over a period of just over a decade. The PDF variants implemented by Apple as spool file formats in successive versions of Mac OS X have usually been sub-sets of a version of PDF as specified by Adobe.

Whenever a new version of a spool file format is released and print subsystems start to create it, RIPs are typically upgraded to accept the new features of the new version. The upgrade falls into two parts; the manufacturer of the printer alters the software code in order to process the new version of the PDL, and then that amended version is installed in the field, for example, by the organizations and individuals who have purchased printers, to replace the older version.

For RIPs running on controllers embedded within printing devices, an upgrade can be complex. The RIP software may be installed as one or more files on a hard-disk within the device, or may be stored as “firmware” within a Read Only Memory (ROM) chip of some form. In some cases the ROM is an Electronically Erasable Programmable Read-Only Memory (EEPROM), which may be re-programmed to replace the previous version of code stored on it. In others, the firmware may only be upgradeable by physical replacement of a ROM chip.

Even where the software or firmware can be upgraded within an embedded controller it is likely to require the manufacturer to provide a specialized tool for the job, and many users are cautious about such upgrades because bugs in the process, or incorrectly following the upgrade instructions, may render the device permanently or semi-permanently inoperable. In some cases it may not even be possible to provide an upgrade in this way if the amended version is now significantly larger than the original, and will no longer fit into firmware that can be supported by the rest of the circuitry in a device.

Therefore a method of enabling older devices to accept a new version of the PDL for which they were designed, but without requiring software or firmware on embedded controller boards to be upgraded or replaced would be advantageous.

To reduce the cost and inconvenience of a new version of a spool file PDL, the organization that owns a spool file format (or a third party) may include at least some support for backwards compatibility in a new version. Thus two variants of spool file format code may be included within the same spool file instance; one using the structures from the new version, and the other using fall-back structures that can be represented in the older version of the spool file format. In many cases such fall-back structures within the spool file format specification may not provide the maximum quality of output that a device could otherwise produce. Depending on the decisions made in designing the file format, they may not even be designed to reproduce the same visual appearance of a page or part of a page. Facility for this kind of backward compatibility is built into the XPS specification, even though that is only in its first version at the time of writing.

Even where the intention is to represent the same visual appearance in different versions of the PDL, the fall-back to the older version of the spool file format may, for instance, involve representing the appearance of a new feature as a pre-rendered raster. Such a raster will have an implicit or explicit resolution (in dots per inch or equivalent unit), color depth (the number of color levels in any one pixel for any one colorant) and color space (e.g. RGB, CMYK etc). In such cases the specifications involved will set out the behavior to be followed by a consuming application (such as a printing device) that only supports an older version of the PDL, and that behavior will include the use of fall-back structures.

As an example, the XPS specification (v1.0), section 2.3.1 references the Ecma International standard “Office Open XML Part 5: Markup Compatibility and Extensibility.” (This standard is in the process of adoption as an ISO standard at the time of writing). Section 9 of that standard describes the technical approach of including fall-back structures, using a variety of versions of a specification. Example 9-1 and FIG. 9-1 explicitly show that the fall-back structures may produce different printed results for devices conforming to different versions of the specification.

If such a raster is created without complete knowledge of the capabilities, requirements, and configuration of the printing device it is unlikely to result in the highest possible quality of rendition when a document is printed. It is even less likely to visually match other areas of the document or page that should appear in the same color on the print, but that are rendered by the RIP on the printing device's embedded controller card.

In addition, many RIPs for office printing devices utilize information about the type of object which makes each mark on the page. Vector fills, for instance, may have different halftone screens applied to them from images, and image data may be automatically reviewed and improved, e.g. by enhancing contrast.

Thus the use of fall-back structures to provide compatibility for changes in PDL versions is likely to be an imperfect solution.

### BRIEF SUMMARY

One embodiment is a method of providing backward compatibility for a newer version of a page description language to a system comprising a computer and a printer coupled to the computer, where the printer is configured and arranged for operation with an earlier version of the page description language and has not been updated for the newer version of the page description language. The method includes providing an updated printer driver with a component that incorporates information about the printer to convert a file in the newer version of the page description language into a file in the earlier version of the page description language while substantially retaining a same visual appearance of the file when printed and compared to the file printed by a printer configured and arranged to print the file using the newer version of the page description language. The updated printer driver is stored on the computer.

Another embodiment is a method of printing a document encoded in a newer version of a page description language using a system comprising a computer and a printer coupled to the computer, where the printer is configured and arranged for operation with an earlier version of the page description language and has not been updated for the newer version of the page description language. The method includes converting the document from the newer version of the page description language to the earlier version of the page description language using an updated printer driver that comprises a component for converting the document that incorporates information about the printer and substantially retains a same visual appearance when printed and compared to the document printed by a printer configured and arranged to print the document using the newer version of the page description language. The document, as converted using the updated printer driver, is printed using the printer.

Yet another embodiment is a computer-readable medium having processor-executable instructions for printing a document encoded in a newer version of a page description language using a system comprising a computer and a printer coupled to the computer, where the printer is configured and arranged for operation with an earlier version of the page description language and has not been updated for the newer version of the page description language. The processor-executable instructions when installed onto a system enable the system to perform actions including i) converting the document from the newer version of the page description language to the earlier version of the page description language using an updated printer driver that comprises a component for converting the document that incorporates information about the printer and substantially retains a same visual appearance when compared to the document printed by a printer configured and arranged to print the document using the newer version of the page description language; and ii) providing the document to the printer.

A further embodiment is a system that is operative to print a document encoded in a newer version of a page description language. The system includes a printer configured and arranged for operation with an earlier version of the page description language, where the printer has not been updated for the newer version of the page description language; and at least one processor coupled to the printer for executing processor-readable instructions that enable actions, including converting the document from the newer version of the page description language to the earlier version of the page description language using an updated printer driver that comprises a component for converting the document that incorporates information about the printer and substantially retains a same visual appearance when printed and compared to the document printed by a printer configured and arranged to print the document using the newer version of the page description language.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic diagram of one embodiment of a system for printing documents, according to the invention;

FIG. 2 is a flow chart illustrating schematically one embodiment of a method of printing a document;

FIG. 3 is a flow chart illustrating schematically another embodiment of a method of printing a document using an updated printer driver, according to the invention; and

FIG. 4 is a flow chart illustrating schematically one embodiment of updating a printer driver, according to the invention.

### DETAILED DESCRIPTION

The present invention is directed to methods, systems, and devices that can be used for providing backward compatibility to a printer or printer system for a new version of a page description language. The present invention is also directed to methods, systems, and devices that include an updated printer driver to provide the backward compatibility.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The following detailed description is, therefore, not to be taken in a limiting sense. The methods described herein can be performed using any type of computing device that includes a processor or any combination of computing devices where each device performs at least part of the process.

Suitable computing devices typically include mass memory and typically include communication between devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Methods of communication can include both wired and wireless (e.g., RF, optical, or infrared) communications methods and such methods provide another type of computer readable media; namely communication media. Communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

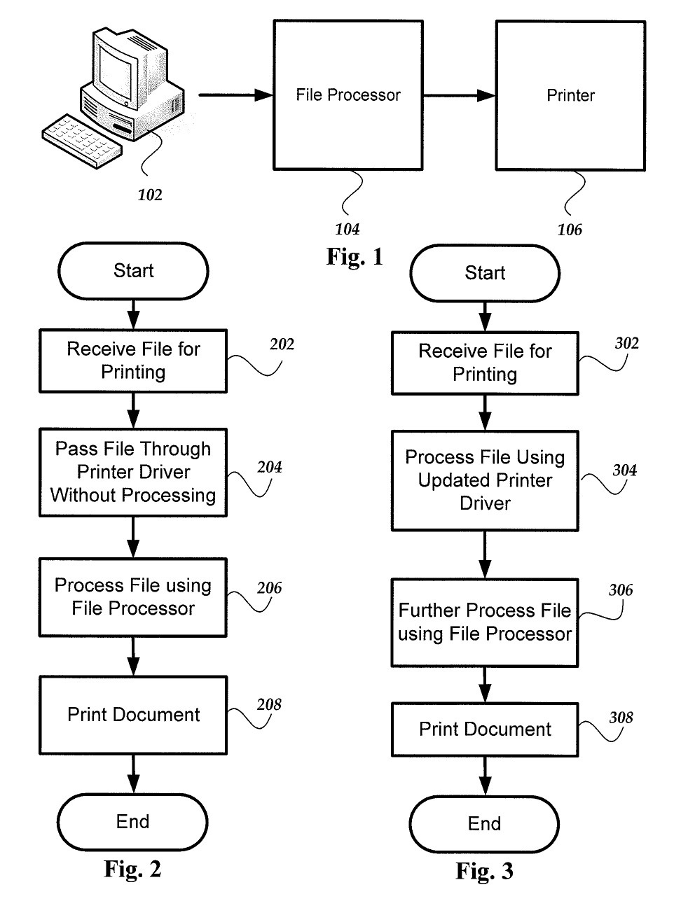

FIG. 1 illustrates one embodiment of a system for printing documents. A computer 102 generates or stores a file, such as a spool file format, to be used in printing the document. The computer 102 includes a printer driver. The file is provided, using the printer driver, to a file processor 104 (such as a Raster Image Processor (RIP)) to convert the file into a format useable by the printer 106 to print the document. As described above, the file processor 104 can be, at least in part, included with the printer 106. It is this file processor 104 that can be updated when a new version of a page description language is released. In those instances where at least a portion of the file processor 104 is resident on the printer, the present invention can be used to provide an updated printer driver with a new component to process the file instead of completely or partially updating the file processor 104.

The printer 106 can be a printing press or any other printing device. In one embodiment, printing is done directly from the RIP to a color printer (for example, an ink-jet printer, a laser printer, or a printer using other printing technology). If printing on a conventional printing press the RIP can be used to image onto, for example, film or plates; if onto film, then that can be used to image plates, and the plates can then be mounted on the printing press to actually perform the printing process.

The present invention is particularly directed to those instances where the spool file format is passed through directly to a RIP on a controller board embedded within a printing device. The printer driver in this situation is normally very simple; in many cases it may perform no processing at all on the spool file format as it is passed through.

One example of such a process is illustrated schematically in FIG. 2. A file is received for printing (step 202). The printer driver passes the file from the computer to the printer without processing (step 204). The file processor (e.g., a RIP) on the printer processes the file (step 206) and the document is printed (step 208).

The present invention is directed, at least in part, to modifying this processing by providing an updated printer driver for converting files in the new version of the PDL to make the files compatible with the older version of the PDL supported by the printer. This updated printer driver uses information about the capabilities and requirements of the printer. FIG. 3 illustrates schematically one embodiment of a method of printing a document. A file in a new version of a PDL is received for printing (step 302). The updated printer driver processes the file to convert the file from the new version of the PDL to an older version of the PDL supported by the printer (step 304). The file processor (e.g., a RIP) on the printer further processes the converted file (step 306) and the document is printed (step 308).

The RIP on the controller board supports a certain version of the spool file PDL. When used with a version of the operating system and print subsystem that creates the same version of the PDL, the print subsystem and controller work together and prints are produced as expected.

If the same simple printer driver and embedded controller are now used with a version of the operating system and print subsystem that support a new version of the PDL, then a number of outcomes may arise:

1) If the new version of the PDL includes new features that change the PDL sufficiently that a RIP for an older version could not interpret the new version, then pages from the new operating system & print subsystem likely would not print and an error message would probably be produced.

2) If the new version of the PDL is designed to be backwards compatible with the old version, but without fall-back structures, then the printer may appear to print correctly, but certain aspects of the output may be missing because the printer does not understand the new features. An example of this case would be the addition of support for transparency in PDF version 1.4; a PDF 1.3 RIP would not realize that it could not process the file correctly, but all elements that were intended to be transparent would be rendered as fully opaque.

3) If the new version of the PDL includes new features, but is designed to include fall-back structures that can be processed by a RIP for the older version, then the job would appear to print correctly, but might not achieve the maximum possible quality on the device in question for the reasons set out above.

Instead of relying on fall-back features in the PDL which typically do not take into account capabilities or requirements of particular printers, a component is added to the printer driver that is programmed to read the new form of the PDL, ignoring the fall-back structures that would normally be used by the RIP on the printer controller board. The component converts the incoming data, encoded in the later version of the spool file format, into a representation in an earlier version of the spool file format that retains the same visual appearance. This conversion, unlike a generic conversion by the print subsystem, is done with knowledge of the capabilities and requirements of the print device with respect to resolution(s), color channels etc. In addition, knowledge about other capabilities and requirements of the embedded RIP, e.g. for data about the object types that have been converted, can also be passed through in a device-specific manner, by using private extensions to the PDL.

Thus, a manufacturer might release a printing device with a RIP on an embedded controller card within it that could accept files using version 1 of a spool file format. The printer driver for the printing device does nothing to the spool file format other than to pass it on to the port monitor that sends it to the device.

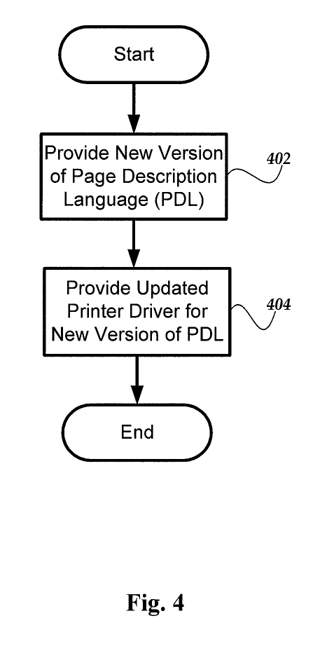

At some later point, version 2 of that spool file format is released as illustrated schematically in step 402 of FIG. 4. Rather than, or as an alternative to, providing an update for the embedded RIP, an updated printer driver that includes the new component that provides compatibility with version 2 can be presented as illustrated schematically in step 404 of FIG. 4. Users of the device would continue to print to it, using either version 1 or version 2 of the spool file format (depending on the version of the operating system and print subsystem that they are using). The combination of printer driver (including the new component) and the printing device itself will handle both versions.

It will be understood that each block of the flowchart illustrations, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustrations support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The computer program instructions, or portions of the computer program instructions, can be stored on any suitable computer-readable medium including, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

An image (for example, a page or other object) can be printed on a medium such as, for example, paper, foil, plastic, fabric, metal, wood, ceramic, and the like. The image can be printed by any printing method including, but not limited to, ink jet printing, laser printing, flexographic printing, lithographic printing, gravure printing, screen printing, pad printing, and the like. The image can include, but is not limited to, pictures, text, graphics, and any combination thereof.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A method of providing backward compatibility for a newer version of a page description language to a system comprising a computer and a printer coupled to the computer, wherein the printer is configured and arranged for operation with an earlier version of the page description language and has not been updated for the newer version of the page description language, the method comprising:
providing an updated printer driver with a component that incorporates information about the printer to convert a file in the newer version of the page description language into a file in the earlier version of the page description language while substantially retaining a same visual appearance of the file when printed and compared to the file printed by a printer configured and arranged to print the file using the newer version of the page description language; and
storing the updated printer driver on the computer.

2. The method of claim 1, wherein the information about the printer comprises information about capabilities or requirements, or both capabilities and requirements, of the printer.

3. The method of claim 1, wherein, prior to providing the updated printer driver, an original printer driver simply passed the file from the computer to the printer without substantial processing

4. The method of claim 1, wherein the newer version of the page description language comprises at least one fall-back structure to provide backward compatibility.

5. The method of claim 4, wherein the updated printer driver is configured and arranged to ignore the at least one fall-back structure.

6. The method of claim 1, further comprising printing a document from a file in the newer version of the page description language and using the updated printer driver.

7. The method of claim 1, wherein the file is a spool file format.

8. A method of printing a document encoded in a newer version of a page description language using a system comprising a computer and a printer coupled to the computer, wherein the printer is configured and arranged for operation with an earlier version of the page description language and has not been updated for the newer version of the page description language, the method comprising:
converting the document from the newer version of the page description language to the earlier version of the page description language using an updated printer driver that comprises a component for converting the document that incorporates information about the printer and substantially retains a same visual appearance when printed and compared to the document printed by a printer configured and arranged to print the document using the newer version of the page description language; and
printing the document, as converted using the updated printer driver, using the printer.

9. The method of claim 8, wherein the information about the printer comprises information about capabilities or requirements, or both capabilities and requirements, of the printer.

10. The method of claim 8, wherein, prior to providing the updated printer driver, an original printer driver simply passed the document from the computer to the printer without substantial processing

11. The method of claim 8, wherein the newer version of the page description language comprises at least one fall-back structure to provide backward compatibility.

12. The method of claim 11, wherein the updated printer driver is configured and arranged to ignore the at least one fall-back structure.

13. A computer-readable medium having processor-executable instructions for printing a document encoded in a newer version of a page description language using a system comprising a computer and a printer coupled to the computer, wherein the printer is configured and arranged for operation with an earlier version of the page description language and has not been updated for the newer version of the page description language, the processor-executable instructions when installed onto a system enable the system to perform actions, comprising:
converting the document from the newer version of the page description language to the earlier version of the page description language using an updated printer driver that comprises a component for converting the document that incorporates information about the printer and substantially retains a same visual appearance when compared to the document printed by a printer configured and arranged to print the document using the newer version of the page description language; and
providing the document to the printer.

14. The computer-readable medium of claim 13, wherein the information about the printer comprises information about capabilities or requirements, or both capabilities and requirements, of the printer.

15. The computer-readable medium of claim 13, wherein, prior to providing the updated printer driver, an original printer driver simply passed the document from the computer to the printer without substantial processing

16. The computer-readable medium of claim 13, wherein the newer version of the page description language comprises at least one fall-back structure to provide backward compatibility.

17. The computer-readable medium of claim 16, wherein the updated printer driver is configured and arranged to ignore the at least one fall-back structure.

18. A system that is operative to print a document encoded in a newer version of a page description language, the system comprising:
a printer configured and arranged for operation with an earlier version of the page description language, wherein the printer has not been updated for the newer version of the page description language; and
at least one processor coupled to the printer for executing processor-readable instructions that enable actions, including:
converting the document from the newer version of the page description language to the earlier version of the page description language using an updated printer driver that comprises a component for converting the document that incorporates information about the printer and substantially retains a same visual appearance when printed and compared to the document printed by a printer configured and arranged to print the document using the newer version of the page description language.

19. The system of claim 18, wherein the information about the printer comprises information about capabilities or requirements, or both capabilities and requirements, of the printer.

20. The system of claim 18, wherein, prior to providing the updated printer driver, an original printer driver simply passed the document from the processor to the printer without substantial processing

21. The system of claim 18, wherein the newer version of the page description language comprises at least one fall-back structure to provide backward compatibility.

22. The system of claim 21, wherein the updated printer driver is configured and arranged to ignore the at least one fall-back structure.

23. The system of claim 18, further comprising a computer coupled to the printer, wherein the computer comprises the processor and the updated printer driver.
